(19) United States
(12) Patent Application Publication
(10) Pub. No.: US 2003/0050891 A1
(43) Pub. Date: Mar. 13, 2003

(54) Method and system for registration and tracking of items

(76) Inventor: James Cohen, Glendale, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/045,954

(22) Filed: Nov. 6, 2001

Related U.S. Application Data
(60) Provisional application No. 60/318,235, filed on Sep. 7, 2001.

(51) Int. Cl. G06F 17/60

(52) U.S. Cl. 705/42

(57) ABSTRACT

The present application discloses a system and method for the registration and tracking of items through a database. Using a recognized financial numbering system as a tracking format, bank notes incorporate unique tracking numbers, which are recorded in the database as corresponding to specific items. Ownership of an item and its corresponding tracking number are registered with the database. Possession of a registered item of personal property by its owner or by another party is can also be registered in the database. Change of title to or possession of a registered item can also be recorded in the database, creating chains of title and possession. Lenders can grant loans, lines of credit, etc. using registered items as collateral and register liens against title with the database. A user can also register with the database any bank note that he or she issues. When a bank receives a bank note for payment, the bank accesses the database to check the bank note's registration status. Un-registered bank notes are flagged for special handling to prevent fraud and forgery.

This application claims priority under 35 U.S.C. 119(e) from U.S. Provisional Application No. 60/318,235, filed Sep. 7, 2001, titled “System for Registration and Tracking of Checks, Documents and Personal Property,” the disclosure of which is hereby incorporated by reference.

### BACKGROUND OF THE INVENTION

1. Field of the Invention

The invention relates generally to methods and systems of registering items and tracking the title, possession, and transactions of items.

2. Description of the Related Art

Labels are often attached to items to track the movement and status of such items. For example, when a customer presents a package to a package delivery company such as Federal Express (FedEx) or United Parcel Service (UPS) for delivery, the company attaches a label with an identification number to the package. The identification number and information about the corresponding package, such as the sender's name and contact information, the sending date, the recipient's name and address, and the status of the package such as “delivered” or “en-route” or “returned”, can be stored in a database. The company updates the status of the package in the database. The customer can enter the identification number into the database to learn the status of the package.

Other systems are also used to identify items. For example, each new automobile sold in the United States has an identification number displayed in the front of the dashboard. This number is usually supplied to state motor vehicle agencies to track the ownership of automobiles. Some museums assign an identification number to each painting in their possession and use a database to maintain information about each painting identified by the identification number.

Although conventional systems allow the tracking of items, system-specific identification numbers are used in these systems to identify and to track items. Typically, identification numbers used in one system cannot be used in another system. For example, a FedEx customer cannot enter a FedEx identification number into an UPS database to learn the status of his or her package. Moreover, a system of identification numbers, including the formats of the numbers, must be created. In addition, conventional systems do not allow comprehensively for the registration and tracking of the changes of title, the changes of possession, the physical location and the collateral status of items.

### SUMMARY OF THE INVENTIONS

Banks notes, or checks, drawn on personal or business checking accounts are wellknown payment drafts issued by banks, savings & loans, credit unions, and other financial institutions, hereafter referred to as “banks.” To facilitate the accurate routing of paper-based or electronic transactions from such accounts, each checking account is given a unique American Bankers Association (ABA) nine-digit routing number identifying the issuing bank and its geographically determined Federal Reserve District. An ABA routing number is issued to a Federal or State chartered bank that is eligible to maintain an account at a Federal Reserve Bank. The ABA routing number for each bank is a unique, non-repeating numerical identifier. Thomson Financial Publishing serves as the ABA's official Registrar in the assigning and administering of ABA routing numbers and maintains a database of current and past assigned ABA routing numbers. In addition to the ABA routing number, other fields of numbers are also printed on checks, in order to identify the bank's branch location, the customer's checking account number, and the individual check number.

While the sequence of the numeric fields following the ABA routing number is at the discretion of the issuing bank, current software technology is able to correctly distinguish the specific numeric fields, regardless of varying field sequence among banks. The resulting fields of numbers are imprinted on each check in order to facilitate automated check processing. Banks print and issue blank checks to their checking account customers. Customers can also purchase acceptable blank check paper and personally print their own checks, or hire the services of an outside printing firm to create personalized checks.

The process for obtaining a checking account customarily requires applicant customers to provide proper identification and other data. A customer may be an individual, a company or any other legal entity. A review of data accumulated in the application process serves as a means of identifying the customer and authenticating ownership of the checking account. Furthermore, the application process for issuing checking accounts results in the accumulation of data regarding the customers.

A tracking number is an identification string recognized by financial institutions as identifying a negotiable instrument. The identification string is preferably a string of numbers, but can also be a string of text symbols or a combination of numbers and symbols. One example of a tracking number is a combination of the ABA routing number and other added numerical fields that are imprinted on a check. Other tracking numbers can also be used to uniquely identify negotiable instruments, for example a credit card account number coupled with an additional identification field such as a check number.

A document containing a tracking number and other requisite data establishing the payer and payee is considered a valid negotiable instrument. An item containing a tracking number and the requisite data can also be considered a valid negotiable instrument. For example, a common rock, inscribed with a tracking number, a face value amount, a name of the payee, and payer's signature can be presented to the payer's bank for payment and would be acceptable as a valid payment draft.

A tracking check is a document that includes a tracking number, a face value amount, an identity of the payee, and a signature of the payer. The tracking check is uniquely identified by its tracking number. The identity of the payee can refer to the name of a specific individual or legal entity, or to a more generic identity such as “Registered Titleholder.” In one embodiment, the tracking check is a valid negotiable instrument recognized by financial institutions.

In one embodiment, a tracking number is attached to an item. For example, the tracking number is printed onto the item or inscribed onto the item. A label that displays the tracking number in bar-coded form or in plain text can be attached to the item. In another embodiment, a tracking check is attached to an item. For example, the tracking check is printed or inscribed onto the item, or attached to the item as a label.

The item is considered associated with its attached tracking number or the tracking number of its attached tracking check. The item and its associated tracking number are registered in a database and identified as corresponding to each other. The database may also store other information about the tracking check that corresponds to the tracking number, such as the face value and the payer name of the tracking check. The database uses the tracking number to identify the item. The database allows the registration and tracking of information about the registered item, such as its changes of title and changes of possession, its physical location, its collateral status, its insurance status, and so forth.

One aspect of the invention relates to a method for tracking physical property with an American Banking Associating routing number. The method includes associating a tracking number with an item of physical property, with the tracking number including at least an American Banking Associating routing number, recording in a database a description of the physical property, and associating within the database the tracking number with the description about the physical property.

Another aspect of the invention relates to a method for registering and tracking an item. The method includes storing information about an item in a database, associating in the database a tracking code with the information about the item, the tracking code also identifying a negotiable instrument, registering in the database an owner of the item, transferring ownership of the item to a second party, and changing the registered owner of the item in the database to the second party.

Yet another aspect of the invention relates to a database for registering and tracking items. The database stores a plurality of items, with each of the stored items including a financially recognized tracking number associated with the item, a name of the item, and a registered owner of the item.

Still another aspect of the invention relates to a method for tracking an item with a financially recognized tracking number, the method including associating within a database a tracking code with data about an item. The tracking code includes financially recognized identification information.

Other aspects and embodiments of the invention are disclosed and claimed below in the detailed description and claims.

### BRIEF DESCRIPTION OF THE DRAWINGS

The details of certain illustrative embodiments, both as to their structure and operation, can be best understood by referring to the accompanying drawings in which like reference numbers and designations refer to their elements.

FIG. 1 is an exemplary diagram of a tracking check.

FIG. 2 is an exemplary format of a tracking check with a plurality of tracking number labels.

FIG. 3 is an exemplary format of a tracking number.

FIG. 4 is an exemplary diagram of a replacement document.

FIG. 5 is an exemplary diagram of an original painting with an attached tracking number.

FIG. 6 is a data flow diagram showing one embodiment of the process of the issuance, application, and registration of tracking checks, tracking numbers, and their corresponding items.

FIG. 7 is a data flow diagram showing one embodiment of the process of using tracking checks to record the sale, repair, and insurance transactions of items associated with tracking checks.

FIG. 8 is a data flow diagram showing one embodiment of the process of accessing data residing in the database shown in FIG. 6 and FIG. 7.

FIG. 9 is a flow diagram showing one embodiment of the process and method of ordering, printing, and delivering tracking checks to customers.

FIG. 10 is a flow diagram showing one embodiment of the process of the sale, resale, real-time registration, and validation of the sale of items and their corresponding tracking checks.

FIG. 11 is a flow diagram showing one embodiment of the tracking check endorsement and redemption process.

FIG. 12 is a flow diagram showing one embodiment of the process of registering checks and confirming check registration to prevent check fraud and forgery.

### DETAILED DESCRIPTION OF PREFERRED EMBODIMENTS

The present application discloses a method of assigning tracking numbers based on the combination of ABA routing numbers and bank-added numerical fields, or other similar tracking systems recognized by financial institutions. The tracking numbers are used to identify items of personal property to establish and maintain a chain of title and possession, and to register and track the title and possession of such items through a database. As used herein, the term “item” refers to a piece of personal property or a document in tangible form. For example, an item can be a limited edition art print, a sports collectable item, a wristwatch, a movie script, etc.

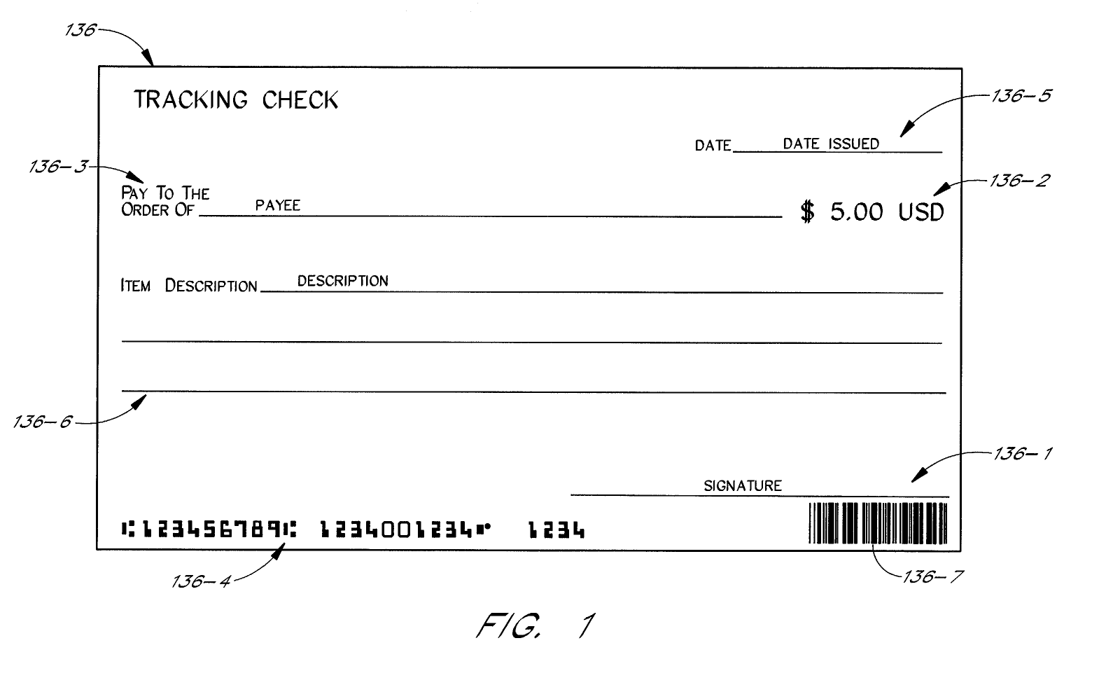

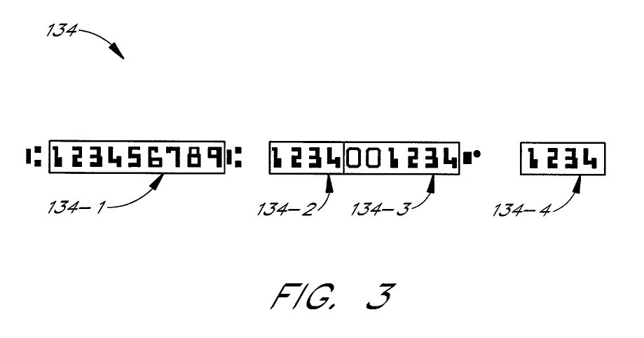

An exemplary diagram of a tracking check 136 is shown in FIG. 1. A tracking check 136 includes a signature 136-1 of the payer, a face value 136-2, a payee field 136-3, a tracking number field 136-4 that displays a tracking number 134 (see FIG. 3), an issued date field 136-5, and a description field 136-6. The face value 136-2 and the tracking number 134 are preprinted on the check by the issuer. The signature 136-1 and the issued date field 136-5 are written by the payer at the time of receiving the tracking check 136. The description field 136-6 contains a description of the item of personal property corresponding to the tracking check 136. Data in the description field 134-6 can be entered at any time prior to the registration of the tracking check 136 with database. Optionally, customer 106 enters a personalized payee name into payee field 136-3, or enters into payee field 136-3 a designation such as “Registered Titleholder.”

The tracking check 136 of FIG. 1 also includes an optional bar code field 136-7, which includes the tracking number 134. A party uses a bar code scanner to scan the bar code field 136-7 to reveal the included tracking number 134. In one embodiment, the tracking check 136 includes the bar code field 136-7, but does not include the tracking number field 136-4.

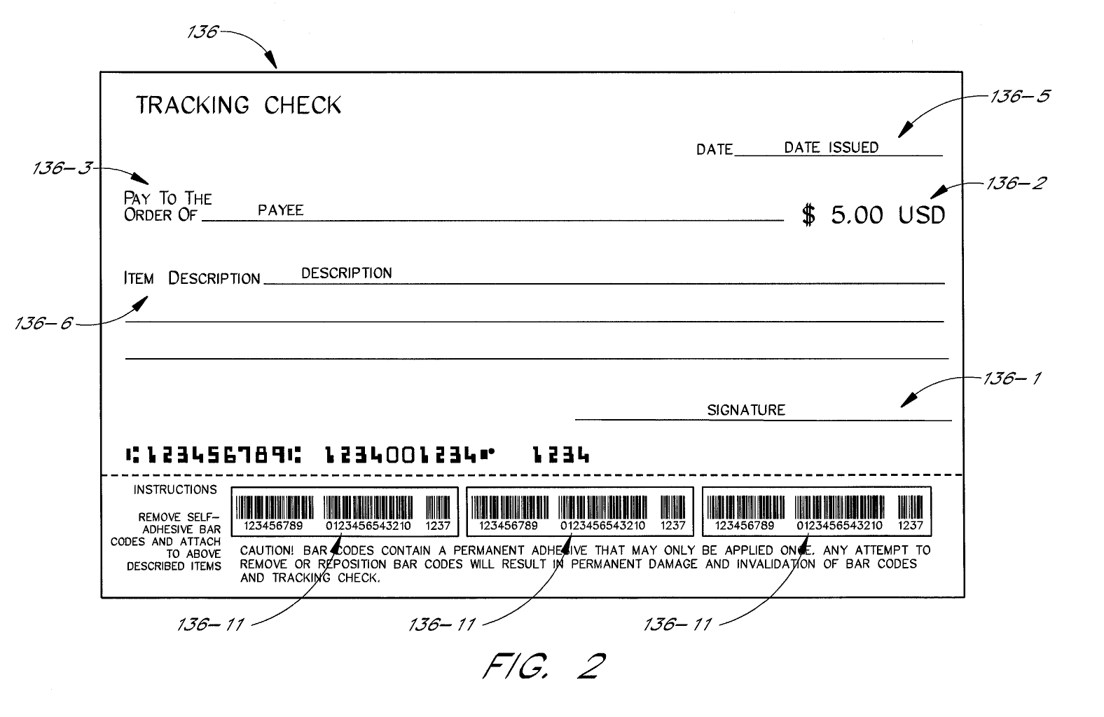

FIG. 2 is an exemplary format of a tracking check 136 with a plurality of tracking number labels. The tracking check 136 includes a signature 136-1 of the payer, a face value 136-2, a payee field 136-3, an issued date field 136-5, and a description field 136-6. The tracking check 136 also includes multiple tracking number labels 136-11. Each of the tracking number labels 136-11 is a bar-coded label of the tracking number 134 that corresponds to the tracking number labels 136-11. In another embodiment, each of the tracking number labels 136-11 is a label of the tracking number 134 in plain text.

The multiple tracking number labels 136-11 can be attached to various locations. For example, when the tracking check 136 is associated with a watch, one label can be attached to a display case of the watch, and another label can be attached to the face bottom of the watch. In another example, when a tracking check 136 is associated with the collective entity of a set of golf clubs, a tracking number label 136-11 is attached to each club. The customer who orders the tracking check 136 from the bank can specify the number of tracking number labels 136-11 to be produced. In one embodiment, when an item associated with the tracking check 136 is being shipped by a package delivery service, a tracking number label 136-11 is attached to the face of the shipping package as an additional form of identification.

FIG. 3 is an exemplary format of a tracking number 134, containing a ABA routing number 134-1, a bank identifier field 134-2, a customer account field 134-3, and a check number field 134-4. The sequence of fields after the ABA routing number 134-1 can be determined at the discretion of a bank or a registration database. Current banking standard uses unique identifiers in the ABA routing number 134-1, in the bank number field 134-2, and in the customer account field 134-3, and allows duplication of check numbers in the check number identifier field. The preferred embodiment uses unique, non-duplicated identifiers in all fields 134-1, 134-2, 134-3, and 134-4 of the tracking number 134, resulting in unique, non-repeating tracking number 134 assigned to each tracking check 136. In addition to numbers that begin with a ABA routing number, other unique, non-duplicated numbers may also be used as tracking numbers 134, for example, a credit card account number combined with a unique check number.

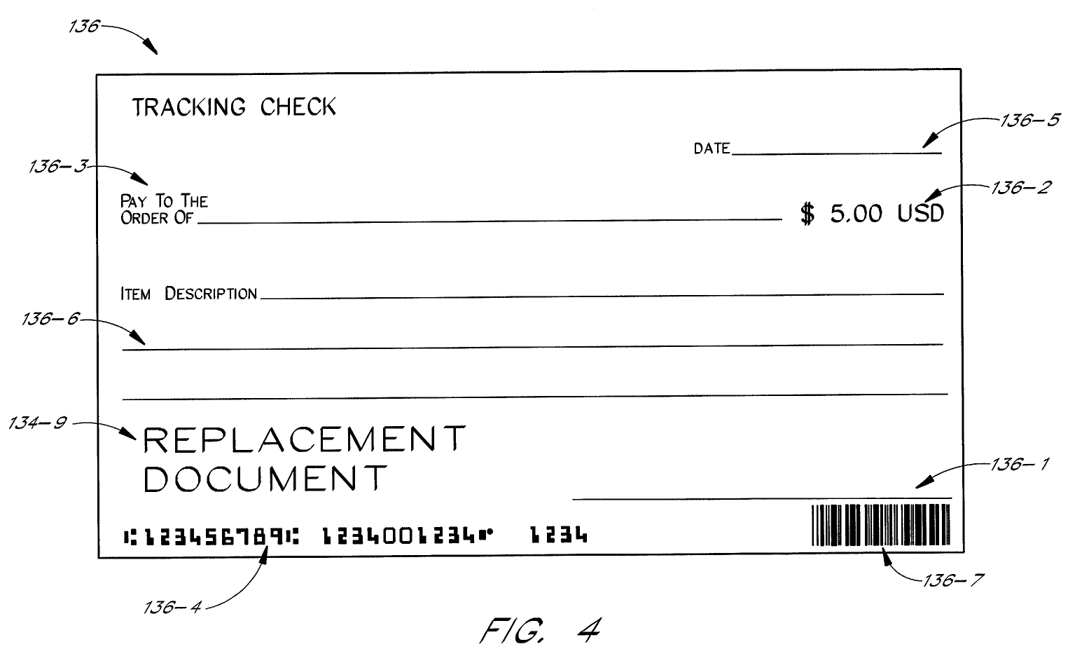

FIG. 4 shows an exemplary diagram of a replacement document for a lost, destroyed, or damaged tracking check 136. A replacement document contains the data fields 136-1, 136-2, 136-3, 136-4, 136-5, 136-6 and 136-7 as an original tracking check 136 in FIG. 1, plus an optional replacement designator 136-9. A replacement document is the legal equivalent to an original tracking check 136, although perhaps without the prestige of an original document. A replacement document may also include multiple tracking number labels, as shown in FIG. 2.

A tracking check 136 or its tracking number 134 can be attached to an item. The term “attached to an item” also refers to being attached to a package, container, or accessory of the item. For example, when the item is a fountain pen, a tracking check 136 or its tracking number 134 can be attached to the pen or to a holding case of the pen.

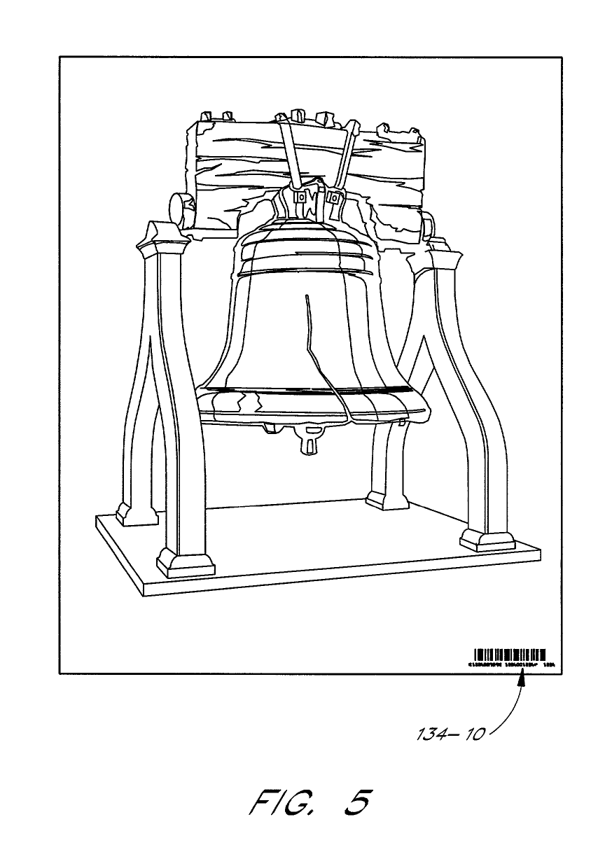

FIG. 5 is an exemplary diagram of an original painting with a bar-coded, permanent-adhesive label attached. The barcode label 134-10 contains the tracking number 134 for the item. By scanning the barcode 134-10 using a scanning device connected directly or remotely to a registration database, information stored in the registration database can be accessed, such as the current titleholder of the corresponding item, the chain of ownership and possession of the item, and so forth. In another embodiment, the entire tracking check 136 is attached to the painting. The tracking check 136 or its tracking number 134 can be attached to the back of the painting.

To use the disclosed method and system, a customer registers with a registration database and enters data regarding the customer. The database creates a customer file for the customer. The database can be, for example, a flat file database, a relational database, an object-oriented database, a combination of a relational database and an object-oriented database, and so forth. The database can be stored on one or more connected computer data-storage devices. At that time or any time thereafter, a customer may apply at a participating bank or licensed location for a unique tracking number 134 to associate with an item of personal property. The application process is similar in nature to applying for a traditional checking account, with the additional steps that the customer provides the specific description of the corresponding item of personal property and a face value for the accompanying document. The negotiable instrument that includes the tracking number 134 is a tracking check 136. The tracking check 136 is recognized by financial institutions as a valid negotiable instrument. The tracking number 134 and optionally description of the item entered by the customer is registered in the database. The bank produces the tracking check 136 and delivers it to the customer. Alternatively, the customer produces the tracking check 136 with the bank's authorization.

Optionally, a customer need not request tracking numbers 134 or receive tracking checks 136 directly from a participating bank. The customer may register with the database and create a customer file in the database for the purpose of documenting his acquisition, sale or transfer of possession of an item which is already registered in the database with a tracking number 134 and a corresponding tracking check 136, as explained below.

Users of the database can use the tracking number 134 to identify the titleholder of the item, to record the face value of the corresponding tracking check 136, to authenticate the item, and to track the title to the item. When the title of the item is to be transferred, or when the possession of the item is to be transferred, or when a lien is to be applied against the item, a party enters the tracking number 134 associated with the item into the database. In one embodiment, the party accesses the database via an electronic device such as a computer, a wired or wireless telephone, a personal digital assistance, and the like, and enters the tracking number 134. In another embodiment, the party telephones an operator of the database, who enters the tracking number 134 into the database. In yet another embodiment, the party scans a label attached to the item that includes the tracking number 134, using a scanner that connects to the database. The party can be one of the parties involved in a transaction, or a third party such as a bank that serves as a referee. The database uses the tracking number 134 to identify the item, its titleholder, and its chain of possession and ownership. In one embodiment, the two parties involved in a transaction access the database to authorize the transaction, in order to prevent mistake or fraud. In another embodiment, the involved parties request a neutral third party, such as a bank, to enter the tracking number 134 into the database.

Upon transfer of title to the item, each successive titleholder registers with the database. A customer file is created in the database for each registrant. Each time title to the item changes from one person to another, the database identifies the new owner as the current owner of the item. In one embodiment, the database transfers the item record, the item's corresponding tracking check record, or the item's corresponding tracking number 134 record to a table of the customer. In another embodiment, the database updates a “owner” field of the item record with the customer identifier of the new owner. In yet another embodiment, the database links the item record to the customer file of the new owner. Other embodiments can also be used to associate the new owner with the item. The accumulated data in the database could thus be used to establish a chain of titleholders, also known as the “provenance” of an item. The provenance can also be used by third parties, such as law-enforcement agencies, insurance companies, and so forth, to determine ownership of an item or to return lost or stolen items to their rightful owners.

The chain of possession of an item can be tracked and stored, regardless of whether the title to an item is transferred. For example, a customer, who is registered in the database and owns an item with a corresponding tracking number 134, transfers possession of an item for service or repair to another party. The change of possession of the item is registered in the database, along with the description of service or repair. In one embodiment, the database updates a “possessed by” field of the item record from the customer identifier of the owner to the customer identifier of the service/repair party. After the item is serviced or repaired, the database records the change of possession of the item from the service/repair party back to the owner. In one embodiment, the serviced or repaired item is returned to the original owner upon verification of his ownership of the tracking number 134 in the database.

By using the tracking numbers 134, repair and service histories can be documented, and possession of the item can be easily tracked. The database can also store records of the quality of work and type of work performed by the service/repair parties, and customer comments about the service/repair parties. Such records can be used to evaluate service/repair parties. Additionally, the database can also record information relating to lien holders and mortgages against the item secured by the titleholder.

The method can be used to register and track items of security concerns, such as knives, guns and explosives. For example, using the tracking number 134 associated with the explosives, a potential explosives buyer can review the transaction history of the explosives as registered in the database, to ensure that the explosives was not stolen or otherwise illegally acquired. A potential explosives seller can ask the potential buyer to register with the database, to ensure that the buyer is a legitimate party. A law enforcement agency can review the transaction history of the explosives as registered in the database, in order to ensure that a criminal has not acquired the explosives. In another example, when a sale or change of possession of the registered explosives is registered with the database, the database automatically notifies a law enforcement agency as to the change in ownership or possession. The database may inform the law enforcement agency of the identified of the new owner or possessor of the explosives, and the current physical location of the explosives.

Check theft, forgery, or fraud is a crime prosecutable under applicable Federal criminal statutes. In addition to any civil liability, by associating tracking numbers 134 and tracking checks 136 with items of personal property, the disclosed method also makes theft, forgery, or fraud associated with items and their corresponding tracking checks 136 a crime prosecutable under applicable Federal criminal statutes. For example, sports jerseys worn by star athletes can be sold with attached tracking checks 136. Once this system achieves sufficient market recognition, buyers may prefer to buy jerseys attached with tracking checks 136. If a seller forges a tracking check 136 and attaches it to a jersey that has not been worn by star athletes, and attempts to sell it as a jersey worn by star athletes, the seller can be prosecuted under Federal criminal statutes. This may serve as additional deterrent to the misrepresentation of items for sale.

By using tracking checks 136, items can be used as collateral without using a pawnbroker. Items can be used as collateral for loans, credit cards, lines of credit, or other purposes. Tracking checks 136 can also be used to categorize items of personal property into one or more portfolios, which could then be used as collateral assets. The lender places a lien against the title to the collateral item or items and their corresponding tracking numbers 134. The lien is recorded in the database. In one embodiment, the database updates a lien field of the corresponding item record with information about the lien, such as the collateral amount, the identity of the lender, and other terms of the lien. In another embodiment, a lien record is created in the database and links to the corresponding item record. Other embodiments can also be used to record liens. A sale or transfer of possession of the encumbered tracking checks 136 and corresponding items can not be registered with the database until after the lender has released the lien or has agreed to the transaction. In one embodiment, the possession of the tracking checks 136 and items can be transferred for certain reasons without the lender's release or agreement, such as for service and repair. Once the loan is repaid or the lien is otherwise satisfied, the lender releases the lien, giving the titleholder clear title.

This process also facilitates lender filings of UCC1 forms. The term “UCC1” refers to a public notice filed with a state government documenting the existence of a lien against or interest in personal property. UCC1 filings are made possible by federal government provision.

In one embodiment, the database also contains insurance data regarding the insured status of registered items, including the name of the insurance company, etc. The insurance data allows lenders and other relevant parties to record insurance coverage of registered items, and allows insurance companies to properly determine inventory, location, and loss payees of insured items.

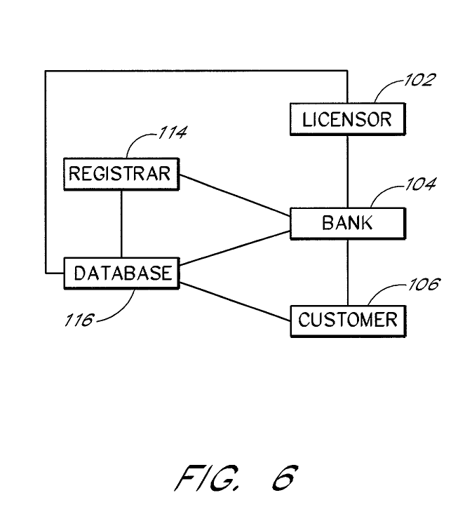

FIG. 6 is a data flow diagram showing one embodiment of the process of the issuance, application, and registration of tracking checks 136 (FIG. 1 and FIG. 2), tracking numbers 134 (FIG. 3), and their corresponding items of personal property.

As shown in FIG. 6, a licensor 102 acts as the administrator of a database's 116 use and application, establishing and enforcing standards and criteria for creation of files, data entry, file access, and data usage in the database 116. The licensor 102 issues a license to a bank 104 to use the database 116 and to use the methods and processes disclosed in the present application. In another embodiment, an original bank 104 or a plurality of banks 104 creates the database 116 and operates the database 116 directly. The original bank or banks 104 authorizes other banks 104 to use the database 116, for example for a license fee.

A registrar 114 is the issuer of ABA routing numbers to the bank 104. In the U.S., Thompson Financial Publishing is the sole registrar of ABA routing numbers. Other systems of routing numbers can also be issued to form tracking numbers 134 and to identify tracking checks 136.

As used herein, the term “ABA routing number” refers to an American banking Association (ABA) unique nine-digit number identifying a specific bank and its geographically determined Federal Reserve District. ABA routing numbers are issued to Federal or State chartered banks that are eligible to maintain an account at a Federal Reserve Bank, and are used to facilitate the accurate routing of paper-based and/or electronic transactions among banks.

Each bank 104 is issued a unique, non-repeating ABA routing number. The registrar 114 regularly maintains a routing number database. The registrar 114 transmits ABA routing numbers from the routing number database to the database 116. In one embodiment, the bank 104 applies for and receives from the registrar 114 a first routing number and a second routing number. The bank 104 uses the first routing number for its traditional practice of issuing checking accounts and blank checks to customers. The bank 104 uses the second routing number 134-1 as part of the tracking number 134 on the tracking checks 136.

In one embodiment, the licensor 102 transmits a bank authorization code to the database 116 and to the bank 104. Upon receipt of the bank authorization code, the database 116 opens a bank file for each bank. Terms such as “bank file” and “customer file” are used for ease of description. However, a bank file may include one or more tables or other units of bank information. A customer file may also include one or more tables or other units of customer information. The database 116 issues access codes such as bank PIN to licensed banks 104, so that the bank employees can access the database 116 using access codes.

The database 116 uses PINs to control access to data in the database 116. A PIN (Personal Identification Number) is a method for electronically gaining access to private data contained in databases. The user enters his/her account number, as provided by the account issuer and gains access to data after entering a PIN. A PIN can be a string of text symbols, a string of numbers, or a string of text symbols and numbers. The term “PIN” as used herein also refers to a password. A database can be programmed to allow access to particular privilege levels or particular areas of data, based on the entered PIN. A database 116 can also be programmed to assign the same PIN to multiple users, but allow the users to each access particular privilege levels or particular areas of data, based on each user's account number. Well-known uses of PINs include ATM machines, telephone calling cards, Internet access passwords, etc. In another embodiment, instead of entering an account number and a PIN, the user enters a text string, which is used to identify the user and to verify the user's authority to enter the database 116.

After the licensor 102 has issued the license to the bank 104, the bank 104 can issue the tracking checks 136. A tracking check 136 includes a tracking number 134. Each tracking check 136 is unique, as it includes a unique tracking number 134. A tracking check 136 can be issued for any face value. In one embodiment, a tracking check 136 can be issued for a face value of zero, and banks 104 recognize a tracking check 136 of zero face value as a valid check. In another embodiment, a tracking check 136 can be issued for a minimum positive face value, such as one cent or one dollar. In one implementation, the minimum face value is determined by the licensor 102, and a tracking check 136 cannot be issued unless its face value is equal to or above the minimum face value. The tracking check 136 can be redeemed at the bank 104 for the face value thereof. The tracking checks 136 can be processed by standard or customized electronic processing systems and processes.

A tracking check 136 corresponds to an item. In one embodiment, a tracking check 136 can also correspond to a plurality of items, for example, a baseball and a baseball bat together as a group of items, or a set of golf clubs. The tracking check 136, with its tracking number 134, and the corresponding item, are registered in the database 116. After a tracking check 136 is registered in the database 116 as corresponding to an item, the database 116 associates the tracking check 136 with the corresponding item.

In one embodiment, the tracking number 134, a description of the corresponding item, are registered in the database 116. Other information about the item, such as the identity of the original titleholder, the changes of ownership, the changes of possession, the physical location of the item, the insurance policy on the item, the collateral status of the item, and so forth, can also be registered in the database 116. In another embodiment, in addition to its tracking number 134, other information about the tracking check 136 are also registered in the database 116, such as the face value amount, the payer, or the payee of the tracking check 136.

A tracking number 134 can be physically attached to a corresponding item, for example by imprinting the tracking number 134 on the item, attaching a label displaying the tracking number 134 to the item, and so forth. A tracking number 134 can be displayed by a number of methods, such as indelible or magnetic ink, a bar-code, an optic code, and so forth.

For example, a bar-coded, permanent-adhesive label containing a tracking number 134 can be attached to an original artwork (see FIG. 5). By scanning the barcode using a device connected to the database 116, a party can access registered data in the database 116 regarding the artwork and its corresponding tracking check 136. To ensure data security and privacy, depending on the identity of the party, only certain data can be accessed by the party.

An applicant applies with the database 116 to create a customer file, by submitting an application by fax, telephone, mail, or via the Internet. In one embodiment, a customer also submits an application fee to the database 116. An applicant can be an individual, a company, or any other legal entity. In one embodiment, applications can be made using standardized application forms, available from the database 116, the bank 104, and participating retail outlets, etc. The database 116 creates a customer file for an approved customer, pursuant to certain standards and criteria regarding the acceptance and rejection of applicants as customers. In one embodiment, the applicant submits the application directly to the database 116. In another embodiment, the applicant submits the application to a bank 104.

The applicant also indicates a preference for method of payment for processing fees. The applicant may optionally choose to authorize the database 116 to automatically charge each processing fee to the applicant's registered credit card, to debit processing fees directly from the applicant's registered checking account, etc.

After the application is approved, the database 116 creates customer records. For ease of description, the present application refers to a customer file as a collection of data for each customer. A customer file can include data from one or more tables or other units of data storage. The database 116 stores data submitted by the applicant and data accumulated as a result of the issuance and processing of tracking checks 136. Data regarding the applicant, the tracking check 136 and the corresponding item can be transmitted from a customer 106 to the database 116 by a computer network or by wired or wireless telephone. The customer 106 can also send information by fax or by mail to be entered into the database 116 by a human operator.

In one embodiment, the customer 106 accesses the database 116 via a wired or wireless telephone using automated menu selection. “Automated menu selection” is a commonly used pre-recorded telephonic instruction-and-response method for inputting data and accessing files in a computer database. A customer calls a dedicated telephone number to gain access to the computer. The caller is given pre-recorded instructions to select specific menu options or input data, by using the keys on a touch-tone telephone or by speaking into the telephone to a voice recognition system.

In one embodiment, any change of title, change of possession, or change of the collateral status of an item requires all involved parties to confirm the action in the database 116. For example, both the buyer and the seller, both the party giving up the possession and the party receiving the possession, or both the borrower and the lender enter their respective PINs into the database 116 to confirm the transaction and its terms. The database 116 then registers the action after the confirmation. For example, the database 116 records the buyer as the item owner, records the receiving party as the item possessor, or records the lien holder of the item.

The database 116 registers one titleholder of an item and one possessor of the item. In the case of joint ownership of a tracking check 136 and the corresponding item, the database 116 considers all joint titleholders as a legal entity. The database 116 establishes a customer file for such a legal entity, and assigns each joint titleholder a PIN. In one embodiment, the database 116 requires joint titleholders to confirm the change of title or change of possession of the item. In another embodiment, one joint titleholder or a majority of joint titleholders can confirm the change of title or change of possession of an item. The terms “buyer,” “seller,” “customer,” “dealer,” “purchaser,” or “secondary purchaser” as used herein can refer to an individual person, corporation, or other legal entity, including joint titleholders. Database 116 thus contains a record of provenance, title, and possession for each item with a corresponding tracking check 136.

If a titleholder to an item sells, transfers possession, or places as collateral the item without registering such action with the database 116, then database 116 will not recognize nor authenticate such unregistered changes. In such a case, the database 116 retains and provides data pertinent to the prior registered actions. Since the item is already registered with a corresponding tracking check 136, the item can not be re-registered with the database 116 using a new tracking check 136. When the database 116 receives a request to register an item and a corresponding tracking check 136, the database 116 checks its records to ensure that the item is not already associated with another tracking check 136.

For example, a buyer purchases an item associated with a registered tracking check 136 and fails to record the purchase at the database 116. When the buyer later attempts to resell the item and register the resale with the database 116, the database 116 recognizes the item as registered with a different titleholder, and will not register the resale, because the buyer is not the registered owner of the item. In one embodiment, the database 116 allows a transaction regarding an item to be registered at a later time.

At the time of a registered change in title to, possession of or encumbrance against an item, the database 116 transmits a confirmation message via email to all involved parties. The confirmation message can appear as instant message on the recipient's computer, by computer-generated fax to the recipient, by mail, by email, or by live or pre-recorded telephone message. The database 116 records the transmittal of the confirmation message to the parties. Other transactions involving the item, such as the purchase and the change of insurance policy, can also be registered at the database 116.

In the embodiment shown in FIG. 6, the customer 106 goes to a business location of the bank 104 and requests that one or more tracking checks 136 be issued to him. In one embodiment, the customer 106 also specifies a face value associated with each tracking check 136. In another embodiment, a tracking check 136 is associated with a standard face value, such as one dollar, five dollars, and so forth, predetermined by the bank 104 or the licensor 102. The customer 106 provides proper identification and other information regarding the customer 106 as desired by bank 104 and its standards and criteria. The customer 106 identifies and describes in detail the item to which the tracking check 136 would be physically attached or otherwise associated. The detailed description of the item is preferably sufficient enough to identify the item. For example, the description can include a drawing or digital photograph of the item to be submitted via email. The description can also include a bar code number, a product ID number, a limited edition number, etc. of the item. At the time of applying for the tracking checks 136, if the customer 106 has not applied for and has not been approved for a customer file in the database 116, the bank 104 or the database 116 will open a customer file for the customer 106, subject to its standards and criteria.

At the time of opening a customer file, the database 116 issues to the customer 106 a customer PIN. The bank 104 collects from the customer 106 an application fee, if applicable. In one embodiment, the application fee is then sent to the database 116. The customer 106 deposits funds with the bank 104. The deposited funds are equal to or greater than the sum of the face value for all tracking checks 136 issued to the customer 106 at that time. The funds can be in the form of a cash payment on deposit with the bank 104, or the customer 106 can authorize the bank 104 to apply a lock against funds already on deposit with the bank 104.

As used herein, the term “lock” means the withholding of access to (a) otherwise available funds valued in an amount equal to the “lock value,” or (b) title to personal or real property valued in an amount equal to the “lock value.” This lock guarantees that sufficient fluids will be available to cover a charge by the authorized holder of the lock, up to the lock value and for the duration of the lock. In a conventional bank account system, the lock is instituted through the bank and operates to place a hold or freeze against a value of funds equal to the lock value. The lock can also be instituted through the bank 104 to place a lien against the title to an item registered with the database 116, until such time as the bank's lien has been satisfied. The lock prevents the customer 106 from using a portion of the funds already on deposit with the bank 104. In one embodiment, funds accrue interest for the duration of the lock period subject to the terms of the agreement between the customer 106 and the bank 104.

The bank 104 orders the production of the ordered tracking checks 136. In one embodiment, the customer 106 also specifies a format for each of the ordered tracking checks 136. For example, depending on the corresponding item, the customer 106 specifies a size and method of attachment for the corresponding tracking check 136. Methods of attachment can include, for example, barcode, inscription, printing, watermark, adhesive label, and so forth. In one embodiment, the tracking number 134 of the tracking check 136 is attached to the corresponding item.

Once a tracking check 136 is produced, the bank 104 transfers the tracking check 136 to the customer 106. The proper identification and other information submitted by the customer 106 during the application process, and the identification and description of item are collectively known as customer data. The customer data are stored in the customer file. In one embodiment, the customer data are also stored in the bank file for the corresponding bank.

Until such time as a tracking check 136 is endorsed and presented to the bank 104 for payment, the bank 104 retains the deposit of funds to cover the face value of the tracking check 136. Once the tracking check 136 is endorsed and presented for payment, the bank 104 releases the lock on the portion of locked funds equal to sum of the face value on the presented tracking check 136. The bank 104 then transmits a lock release message to the database 116. Upon receipt of the message, the database 116 records the tracking check 136 as “cashed” or “cancelled”. The database 116 then transmits lock release confirmation message to involved parties, such as the registered owner of the tracking check 136. Since it is anticipated that the face value of the tracking check 136 is preferably significantly less than the value of the corresponding item, in most cases, the tracking check 136 is likely never redeemed, giving bank 104 an deposit of funds for a permanent duration.

For example, an item can be an autographed Michael Jordan jersey with a retail value over $2,000, and its tracking check 136 can have a face value of $10. The tracking number 134 of the tracking check 136 can be attached to the jersey, for example using traditional or magnetic embroidery, barcode, indelible ink, etc. In another embodiment, the tracking check 136 itself can be attached to the jersey. Over a period of time, title to the jersey can be repeatedly transferred, but the corresponding tracking check 136 is not likely to be endorsed and presented for payment of the ten-dollar face value. Each successive purchaser of the jersey registers with the database 116 subsequent changes of ownership and possession of the jersey, and uses the attached tracking check 136 as authentication of the jersey. Since each purchaser considers the authentication value served as the tracking check 136 to be greater than the $10 face value, the purchaser will not redeem the tracking check 136, and the bank 104 retains a deposit of the ten dollars.

In one embodiment, it is assumed that tracking checks 136 are never redeemed and that the face value of a tracking check 136 serves as a service fee for the database 116 and the bank 104. Customer 106 is given this information at the time of application and agrees that the tracking check 136 cannot be redeemed. Instead of locking an amount equal to the face values of the tracking checks 136, the bank 104 then deducts the face values from the customer's account as service fees.

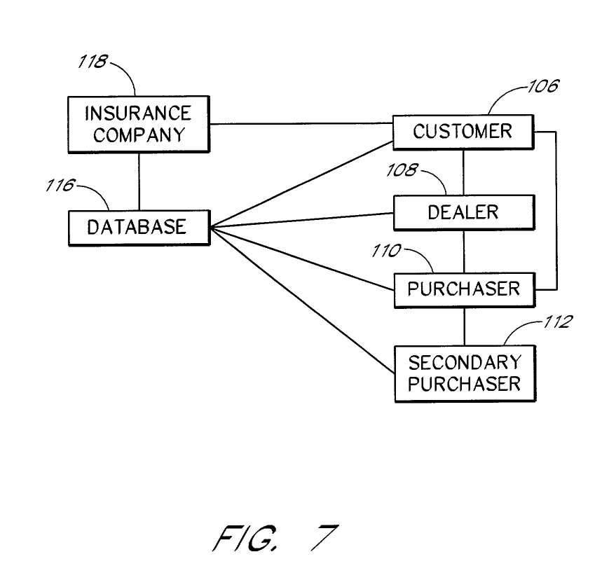

FIG. 7 is a data flow diagram showing one embodiment of the process of using tracking checks to record the sale, repair, and insurance transactions of items associated with the tracking checks 136. In order to preserve the visual clarity of FIG. 7, the licensor 102, the bank 104, and the registrar 114 as shown in FIG. 6 are not displayed again in FIG. 7.

A change of title to an item and the corresponding tracking check 136 also constitutes a change of title to the locked funds that cover the face value of the tracking check 136. Consequently, database 116 registers the change of title in the bank file. In the case that a change in title to the finds results in a change of bank 104 (i.e., the buyer and the seller belong to different banks), database 116 records the change of titleholder of funds in the respective bank files of the respective banks 104. Database 116 can also transmit confirmation message to the buyer, the seller, and the two banks 104. Optionally the buyer or the seller can choose to change his/her banking relationship to the bank 104 of the other party. The bank 104 of the buyer becomes the depository of funds. Database 116 registers change of depository in the respective bank files. In another embodiment, the buyer's bank locks the buyer's funds sufficient to cover the face value of the tracking check 136, and the seller's bank releases the previously locked funds to the seller.

A tracking check 136 can also be used to track possession of an item in the case when title is not conveyed. In one embodiment, the licensor 102 issues a license to a dealer 108 to use the methods and processes disclosed in the present application. The licensor 102 transmits a dealer authorization code to the database 116 and the dealer 108. Upon receipt of the code, the database 116 opens a dealer file and issues to the dealer 108 a dealer PIN. In another embodiment, the dealer 108 directly registers with the database 116 to open a dealer file, without first contacting the licensor 102. The dealer file includes an inventory of customer items currently in the possession of the dealer 108.

As illustrated in FIG. 7, the customer 106 takes an item to the dealer 108 for service or repair. The corresponding tracking check 136 provides the dealer 108 with proof of title to the item. In order to take possession of the item, the dealer 108 or the customer 106 accesses the database 116 using his or her respective PIN. One of the two parties enters into the database 116 the change of possession, the purpose of such change, the services to be performed, the anticipated date of return of the item to the customer 106, and the like, collectively referred to hereafter as dealer data. The other of the two parties then enters his/her respective PIN to confirm the change of possession. The database 116 then stores the dealer data into the dealer file and the customer file. The dealer data can be entered into tables of dealer records and customer records, or otherwise associated with the dealer file and the customer file. Optionally, the database 116 also transmits a confirmation message to all relevant parties. In one embodiment, the database 116 deducts a transaction fee from the financial accounts of the customer 106, the dealer 108, or both. In another embodiment, the dealer 108 collects a transaction fee from the customer 106, and optionally remits it to the database 116.

Upon return of the item to the customer 106, one of the two parties enters into the database 116 the change of possession, the date of return of the item to the customer 106, and optionally other information. The other of the two parties then enters his/her respective PIN to confirm the change of possession. The database 116 then records the change of possession in the dealer file and the customer file, and optionally transmits a confirmation message to all relevant parties. The database 116 thus contains a record of all changes of possession to the item as well as services performed. In one embodiment, the dealer 108 and the customer 106 can enter comments about each other into the database 116. In one implementation, the comments about the customer 106, the comments about dealer 108, or both comments can be accessed by other parties such as other customers and other dealers in order to evaluate the customer 106 and the dealer 108.

For example, an item can be a Rolex watch and the dealer 108 can be an authorized Rolex service center. By registering change of possession to the Rolex service center each time the watch is serviced, the customer 106 has a documented record of possession and service history of the watch. This results in a potentially higher resale value in the event the customer 106 decides to sell the watch, as well as possible lower insurance costs during the period of ownership.

In another embodiment shown in FIG. 7, the customer 106 can consign or loan an item to the dealer 108. At the time of taking possession of the item, the dealer 108 accesses the database 116 using the dealer PIN. The dealer 108 enters the tracking number 134 associated with the item, the date of receipt, the physical condition of item, and the dealer 108's physical storage location of item, and other pertinent data. The customer 106 enters customer PIN to confirm the change of possession. In one embodiment, the dealer 108 or the customer 106 remits a transaction fee to the database 116. The database 116 records the dealer-entered transaction data, and optionally transmit a confirmation message to all relevant parties. The database 116 thus contains a detailed inventory of items consigned to the dealer 108. The customer 106 and the dealer 108 are both able to track at all times the possession and physical location of the item.

As shown in FIG. 7, acting as an agent for the customer 106, the dealer 108 can offer an item for resale to the purchaser 110. A tracking check 136 provides each purchaser 110 with authentication of the item and documentation of title, potentially increasing the sale value of the item. The purchaser 110 applies with the database 116 to create a purchaser file prior to the purchase of the item or at the time of purchase. The purchaser 110 directly applies with the database 116 or applies through a third party such as a bank 104. The purchaser 110 provides to the database 116 proper identification and other information regarding purchaser 110, hereafter referred to as purchaser data. The purchaser data also includes information about the sales transaction provided by the purchaser 110 to the database 116 regarding the purchase of an item. The purchaser 110 pays an application fee, if applicable, to the database 116. The database 116 creates a purchaser file and issues a purchaser PIN to the purchaser 110.

One of the two parties, the dealer 108 or the purchaser 110, accesses the database 116 using his/her respective PIN and enters purchase terms such as price, delivery terms, and warranty terms into the database 116. The other party enters his/her PIN to confirm the transfer of title, and the change of possession of the item. In one embodiment, if the change of possession of the item happens at a time later than the transfer of title, the parties may access the database 116 at the later time to confirm the change of possession. In one embodiment, the dealer 108 collects the transaction fee from the purchaser 110 and remits it to the database 116.

The database 116 then records purchaser data in the dealer file and the purchaser file, and identifies the purchaser 110 as the new owner of the tracking check 136 and the corresponding item. In one embodiment, the database 116 stores a name or identifier of the purchaser 110 in an owner field for the record of the tracking check 136. In another embodiment, the database 116 stores a name or identifier of the purchaser 110 in an owner field for the record of the corresponding item. The database 116 optionally transmits a confirmation message to all relevant parties. By accessing the dealer file, the dealer 108 is able to track and document all sales of items consigned by the customer 106, and to establish documented provenance.

For example, the customer 106 can be an artist, the items can be limited edition prints, and the dealer 108 can be an art gallery. The artist attaches a tracking check 136 or its tracking number 134 to each signed and numbered print in the edition. The artist enters the database 116 to change the possession of a print to a displaying gallery. The gallery enters into the database 116 the physical location of the print and the sold/unsold status of the print. This process can be especially useful in tracking prints, in the event a gallery has more than one business location, or transfers possession of prints to other galleries or to purchasers. The gallery or the purchaser also enters into the database 116 information about the purchases. By accessing the database 116 using his/her PIN, the artist can at any time determine the physical location and the sold/unsold status of each print, and the gallery can determine the physical location and purchaser of each print.

Authorized insurance firms can be provided with limited access to the database 116 to review information about an insured item, such as its history of title, history of possession, price, physical location, and sold/unsold status. When an item is sold, the database 116 automatically sends a message to the last party that pays for insurance on the item (such as the last owner or possessor of the item), to remind that party to terminate the insurance coverage. The database 116 can also automatically send a message to the last insurance company that insures the item, to remind it that the item has been sold. The database 116 may also automatically send a message to the new owner or possessor of the item, to remind the new owner or possessor to purchase insurance.

As shown in FIG. 7, a purchaser 110 can sell item to a secondary purchaser 112. The tracking check 136 provides the secondary purchaser 112 with authentication and provenance for the item purchased from the purchaser 110. The secondary purchaser 112 applies to the database 116 for a secondary purchaser file. The secondary purchaser 112 applies to the database 116 directly or through a third party such as a bank 104. The secondary purchaser 112 provides database 116 with secondary purchaser data, including proper identification and other information regarding the secondary purchaser 112. The database 116 creates the secondary purchaser file and issues secondary purchaser PIN to the secondary purchaser 112. The secondary purchaser 112 pays the database 116 an application fee, if applicable.

At the time of the sale of the item, one of the two parties, the purchaser 110 or the secondary purchaser 112 accesses the database 116 using his/her PIN and enters information about the secondary purchase transaction, such as price, delivery terms, and so forth. The other party accesses the database 116 using his/her PIN to confirm transfer of title and possession to the item. The database 116 then records the transaction and records the secondary purchaser 112 as the new owner. In one embodiment, one of the parties remits a transaction fee to the database 116. The database 116 optionally transmits a confirmation message to all relevant parties. Since an item can be sold multiple times, there can be multiple secondary purchasers 112, resulting in a chain of titleholders. The two secondary purchasers 112 can use the above-described process to confirm a secondary purchase transaction.

In another embodiment shown in FIG. 7, the customer 106 can sell an item directly to a purchaser 110, independent of dealer 108. As before, the database 116 provides the purchaser 110 with authentication of the item and documentation of title, thereby potentially increasing the sale value of the item. The purchaser 110 applies with the database 116 to create a purchaser file. The purchaser 110 provides the database 116 with proper identification to identify the purchaser 110. After the purchaser 110 and the customer 106 agree on terms of the sales transaction, the two parties access the database 116 to enter the terms of the transaction and to confirm the transaction. In one embodiment, the customer 106 collects a transaction fee from the purchaser 110 and remits it to the database 116. The database 116 records information about the transaction in the customer file and the purchaser file. The database 116 optionally transmits a confirmation message to all relevant parties. By accessing the database 116, the customer 106 is able to track and document all sales of the item.

In embodiments other than that shown in FIG. 7, the customer 106 can be a manufacturer, distributor, or reseller of an item, operating through or independent of a dealer 108. The customer 106 can be an agent acting on behalf of another party to whom title and possession of item will eventually pass. Each customer is registered in the database 116. Each change of title or possession is registered in the database 116.

In a further embodiment, a tracking check 136 can be purchased and used to document and to authenticate the title to an item already in a titleholder's possession. For example, the customer 106 can be a museum and an item can be an original painting. The museum purchases a tracking check 136 from the bank 104 and physically attaches the tracking check 136 to a painting in its possession. Museums customarily loan paintings to other museums or rent to others paintings not in the permanent collection or not currently on exhibit. The museum enters into the database 116 the change of possession of each painting on loan or rent, as well as the physical location of each individual painting in its own custody, whether on exhibit or in storage. By accessing the database 116, the museum can at any time determine the physical location of each individual painting. Authorized insurance firms can be provided limited access to the database 116 to review information about each painting, such as its current physical location, and so forth.

Tracking checks 136 can be issued with different face values for otherwise identical corresponding items, such as limited edition prints of the same artwork, to provide an additional security measure against fraud and forgery. A customer 106 can maintain within its customer file a confidential listing of the specific amount of each tracking check 136. By comparing the face value on a tracking check 136 to the face value listed in the database 116 for said individual tracking check 136, the customer 106 can further guarantee the authenticity of a tracking check 136.

For example, the customer 106 can allow access to the customer file in the database 116 to a third party such as a dealer or a potential purchaser, so that the third party can verify that the face value listed in the database 116 is identical to the face value displayed on the physical tracking check 136. In another example, each of the limited edition prints has a tracking check 136 with a different face value. Therefore, even if a potential forger has access to one of the prints and knows the face value on that print, the potential forger does not know the face value on other prints that the potential forger does not have access to. As a result, the potential forger cannot forge the other prints with the correct tracking check 136 face values.

Tracking checks 136 can also be used as a method of categorizing personal property into portfolios, which can then be used as collateral assets for loans, lines of credit, or credit cards. As used herein, the term “portfolios” means a detailed schedule of personal property, along with a valuation thereof and corresponding tracking checks 136.

In one embodiment, the titleholder submits a portfolio to the bank 104 as collateral for a line of credit, a personal or business loan, or a secured credit card. In one embodiment, the collateral amount corresponds to the aggregate face values of the tracking checks 136 in the portfolio. In another embodiment, the collateral amount corresponds to the aggregate valuation of the corresponding items. Upon granting the line of credit, loan, or credit card, the bank 104 places a lien against the titles of the specified tracking checks 136 and corresponding items, and transmit a lock message to the database 116. The titleholder enters his/her PIN to confirm the lock. The database 116 optionally transmits confirmation message to all involved parties. The database 116 records the lock in the bank file and the file of the titleholder. For the duration of the lock period, the database 116 prevents the titleholder from registering any change of title or possession to the encumbered tracking checks 136 and corresponding items. In one embodiment, database 116 allows the titleholder to transfer possession to the items for limited purposes, such as for service and repair.

Upon satisfaction of the lien, the bank 104 transmits a release lock message to the database 116. Upon receipt of the message, the database 116 optionally transmits confirmation message to all involved parties. The database 116 records the release of lien in the files of all related parties, and the titleholder has clear title of tracking checks 136 and the corresponding items.

Still referring to FIG. 7, the database 116 also includes provisions for verification and confirmation of insurance status for all items registered therein. Each insurance company 118 may operate with multiple business locations nationally and internationally. An insurance company 118 insures one or more items owned by a titleholder and registered with the database 116.

In one embodiment, the customer 106 and the insurance company 118 reach an agreement regarding an insurance policy on an item owned by the customer 106. One of the parties, the customer 106 or the insurance company 118, accesses the database 116 using his/her PIN, and enters the identity of the item to be insured, the identity of the insurance company 118, and the terms of the insurance policy. The other party accesses the database 116 using his/her PIN and confirms the insurance transaction. The database 116 optionally transmits confirmation message to all involved parties. The customer 106 is able to document the insured status of the insured item. In one embodiment, the customer 106 or the insurance company 118 grants permission for another party, such as a dealer or a potential purchaser to access and to confirm the insured status. In one embodiment, when a change of title to the item is registered with the database 116, the database 116 notifies the insurance company 118. In another embodiment, the database 116 also notifies the insurance company 118 when a change of possession of the item is registered.

In the event a tracking check 136 is lost, destroyed, or stolen (but the corresponding item is not lost, destroyed, or stolen), the current registered titleholder customer 106 can apply to the database 116 for a replacement tracking check 136, pay a processing fee, and optionally sign an affidavit that the original tracking check 136 was indeed lost, destroyed, or stolen. Optionally, the customer 106 submits to the database 116 evidence to confirm the loss, destruction or theft, such as a police report, etc. A new replacement tracking check 136, optionally containing the words “Replacement Document” (see FIG. 4) or another symbol or mark identifying its replacement status, is then issued by the database 116 and delivered to the customer 106. The issuance of the replacement document is recorded in the database 116. The original missing or destroyed tracking check 136 is recorded as voided in the database 116.

If both the tracking check 136 and the corresponding item are lost, destroyed, or stolen, and a payout to the current, registered titleholder is made by an insurance company 118 according to an insurance policy, the insurance company 118 then becomes the new titleholder of the tracking check 136 and item. The database 116 records the reported loss or destruction of the item, the insurance payout, and the transfer of title to the insurance company 118.

Regardless of whether the corresponding item is lost, stolen, or destroyed, it is not mandatory for the titleholder to replace a lost, stolen, or destroyed tracking check 136. However, without an original or replacement tracking check 136, any subsequent change of the title or possession of the corresponding item can not be registered in the database 116, nor can the item be presented to the bank 104 for endorsement and payment of the face value of the lost, stolen, or destroyed tracking check 136.

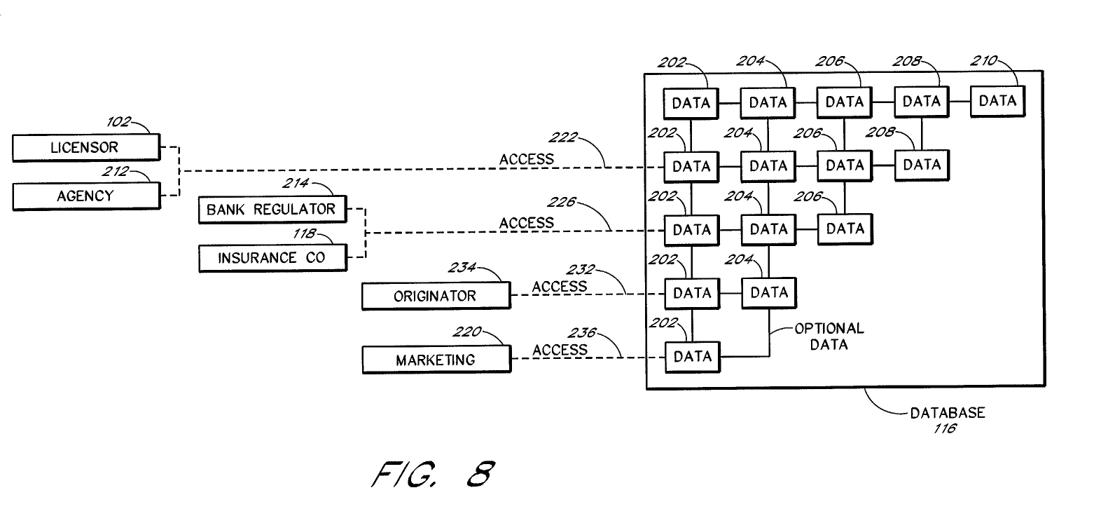

FIG. 8 is a data flow diagram showing one embodiment of the process of accessing data residing in the database shown in FIG. 6 and FIG. 7. In order to protect the privacy of database 116 users, access restrictions are imposed. Data 202, data 204, data 206, data 208, and data 210 represent pre-determined categories of data residing in database 116. Data 202 is the least private and consequently most accessible category of data. For example, data 202 can include data necessary to establish the identity of an item to which a change of title or possession would occur, including a physical description of the item and its tracking number 134 on the corresponding tracking check 136. Data 202 may also include general demographic data regarding the titleholder. The data 204, data 206, data 208, and data 210, respectively, includes increasingly private data, with data 210 being the most private, and consequently, least accessible data.

A file owner's access to data contained in the database 116 does not constitute a blanket authority to change data pertaining to that file owner residing in the database 116. Upon entering his/her PIN, a file owner is granted permission to change data in his/her personal profile. Data that should not be changed by the accessing party can be made available to the accessing party on a read-only basis.

As used herein, the term “personal profile” refers to the data identifying an individual entity. A personal profile includes current address and contact data, proper identification, and other data gathered in the account application process, as typified by a traditional bank account application. Personal profile data can be categorized into increasing levels of privacy. Personal profile can also include the individual entity's optional grant of access permission to various levels of private data. For example, an individual entity can optionally choose to grant marketers access to certain data in order to receive newsletters or email solicitations of perceived interest to the individual entity.

In one embodiment, the licensor 102 and an agency 212 have access to data stored in the database 116. In the embodiment shown in FIG. 8, the licensor 102 and the agency 212 have access link 222 to data 202, data 204, data 206, and data 208. As used herein, the agency 212 means local and national law enforcement agencies and other government agencies having jurisdiction over the licensor 102 or the database 116. Some agencies 212 have multiple locations nationally and internationally. The database 116 assigns access authorization to each designated, registered member of each registered agency 212 by means of agency PIN. In one embodiment, a minimum of two registered members of agency 212 enter their respective PINs in order for the database 116 to grant access. Access link 222 allows the agency 212 to investigate theft, forgery, fraud or other criminal cases involving items or their titleholders, as registered in the database 116, or to reunite lost or stolen items with their registered titleholders.

In one embodiment, a bank regulator 214 and the insurance company 118 have access link 226 to data stored in the database 116. In the embodiment shown in FIG. 8, the bank regulator 214 and the insurance company 118 have access to data 202, data 204, and data 206. Some bank regulators 214 and insurance companies 118 may have multiple locations nationally and internationally. The insurance company 118 preferably is allowed access to data relevant to the items it insures. The database 116 assigns access authorization to each designated, registered member of each registered bank regulator 214 and insurance company 118 by means of bank regulator PINs and insurance company PINs, respectively. The bank regulator 214 has access to data pertaining to funds on deposit with banks that cover the face value amounts of registered tracking checks 136. The access link 226 facilitates the insurance company 118 investigations of claims of lost, stolen, damaged or destroyed items, as registered in the database 116, potentially reducing insurance costs to registered titleholders.

The database 116 also grants access to an originator 218. An originator 218, as used herein, means a bank, customer, dealer, purchaser, or secondary purchaser that transmitted unique, personal data to the database 116 as part of an application process, or as part of a registration of transfer of title, transfer of possession, and lien process. In the embodiment shown in FIG. 8, the originator 234 has access link 232 to data 202 and data 204. The database 116 issues a PIN to each originator 218. By use of the PIN, the originator 218 gains access to its personal profile. The access link 232 allows the originator 218 to track possession of all items registered in the database 116 to which originator 218 has title or possession.

A marketing unit 220 is granted the least access to data stored in the database 116. As used herein, a marketing unit 220 means an internal marketing department of the bank 104 or the licensor 102, or an outside marketing firm. A marketing unit may have multiple locations nationally and internationally. In the embodiment shown in FIG. 8, the marketing unit 220 only has access link 236 to the data 202. The access link 236 is the lowest level of access to data stored in database 116 and can be used by the marketing unit 220. By granting permission to its personal profile, an originator 218 can optionally choose to make its personal data available to the marketing unit 220 as well. In one embodiment, the marketing unit 220 is also allowed to advertise to the originator 218 purchase, service, or other opportunities of potential interest to the originator 218.

In other embodiments, the access levels of data in the database 116 can be organized differently. For example, in one embodiment, the bank regulator 214 and the insurance company 118 can be granted the substantially same level of access as the licensor 102 and the agency 212. In another embodiment, the agency 212, the bank regulator 214, and the insurance company 118 can access certain data pertaining to an originator 234, but not all data pertaining to the originator 234. A court order may be required to access certain data of an originator 234.

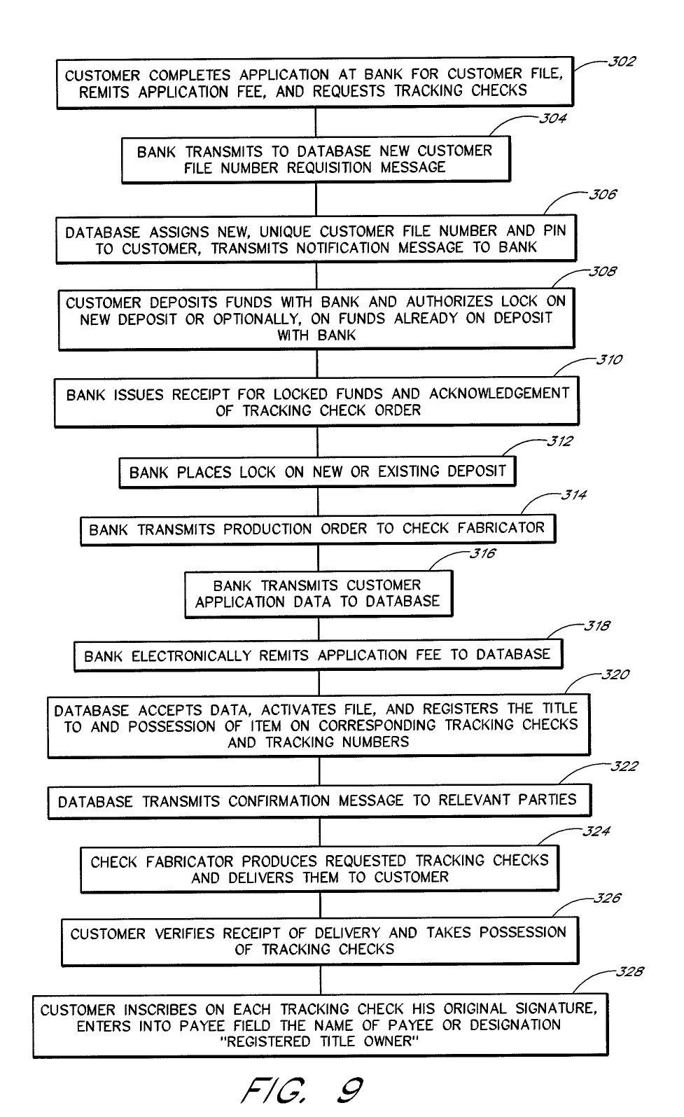

FIG. 9 is a flow diagram showing one embodiment of the process and method of ordering, printing and delivering a tracking check 136 to a customer 106. In this embodiment, the process starts when the customer 106 applies to the database 116 for a customer file and PIN. In another embodiment, the customer 106 has applied for and received a PIN from the database 116, and the database 116 has already created a customer file for the customer 106. The process begins with step 302, in which, in this embodiment, the customer 106 completes an application for a customer file at bank 104, remits the application fee, if applicable, and requests from the bank 104 tracking checks 136. In another embodiment, the customer 106 applies directly to the database 116 without contacting the bank 104. Included in the application data is optionally proof of title to and description of the item with which each tracking check 136 will correspond. The customer 106 may optionally specify a face value and a format for each ordered tracking check 136. In step 304, a bank employee enters his/her PIN into a computer terminal and transmits to the database 116 a new customer file requisition message. The message can also be sent to the database 116 automatically, without human direction. The database 116 assigns a customer file and PIN to the customer 106 in step 306, transmits the PIN in a notification message to the bank 104 and awaits activation data input from the bank 104. In step 308, the customer 106 deposits with the bank 104 the aggregate total of the face value of the requested tracking checks 136 and authorizes the bank 104 to place a lock on said deposit. Optionally, in lieu of a new deposit, the customer 106 authorizes the bank 104 to place a lock on funds already on deposit with the bank 104. In step 310, the bank 104 issues to the customer 106 a receipt for the deposited or locked funds and an acknowledgement of the tracking check order.

In step 312, the bank 104 places a lock on the new or existing deposit. In step 314, the bank 104 transmits a production order to a check fabricator for the production of the requested tracking checks 136 in the specified face values and formats. In step 316, the bank 104 transmits to the database 116 the data received on the customer application form. In step 318, the bank 104 electronically remits an application fee to the database 116. In step 320, the database 116 accepts the transmitted data, activates the customer file, and registers in the customer file and the bank file the title to and possession of the item on the corresponding tracking check 136 and tracking number 134. In step 322, the database 116 transmits to the bank 104 a confirmation message that the data has been entered to the appropriate files. Steps 316, 318, 320, and 322 can also be performed together with step 306. In step 324, the check fabricator produces the requested tracking checks 136 and delivers them to the customer 106. In step 326, the customer 106 verifies receipt of delivery and takes possession of tracking checks 136. In step 328, the customer 106 signs on each tracking check 136 his original signature, and enters into the payee field the name of the payee or a designation such as “Registered Title Owner.” The bank 104, the check fabricator or the customer 106 also attaches the tracking checks 136 to the corresponding items. In one embodiment, instead of attaching the tracking check 136 to the item, the bank 104, the check fabricator, or the customer 106 attaches the tracking number 134 of the tracking check 136 to the corresponding item, for example printing the tracking number 134 on the item, or attaching a label displaying the tracking number 134 to the item.

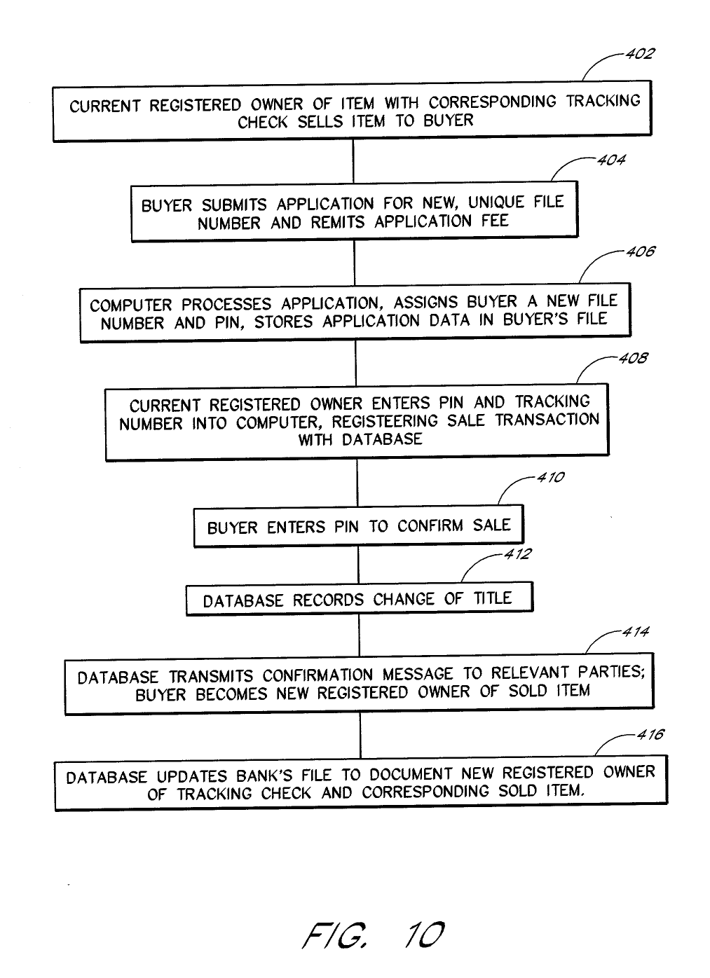

FIG. 10 is a flow diagram showing one embodiment of the process of the sale, resale, real-time registration, and validation of sale of items and their corresponding tracking checks. In this embodiment, the process starts when the customer 106 applies to the database 116 for a customer file and PIN. In another embodiment, the customer 106 has applied and received a PIN from the database 116, and the database 116 has already created a customer file for the customer 106. The process begins with step 402, in which the current registered owner of an item with a corresponding tracking check 136 sells the item to a buyer. In step 404, the buyer accesses the database 116 via a networked computer terminal, wired or wireless phone, fax, etc., completes an application for a customer file and remits an application fee. In step 406, the database 116 processes the application, assigns the buyer a PIN and creates a customer file for the buyer, and stores the application data in the buyer's file. In step 408, the current registered owner accesses the database 116 via a networked remote computer terminal, wired or wireless phone, fax, etc., enters his/her PIN, the tracking number 134 corresponding to the sold item, and registers the sale transaction with the database 116. In step 410, the buyer enters his/her PIN into the database 116 to confirm the sale. In another embodiment, the buyer registers the sale transaction with the database 116, and the currently registered owner confirms the sale.

In step 412, the database 116 records the buyer as the new owner of the sold item. The database 116 also records the price, date and time, and other terms of the sales transaction. In step 414, the database 116 transmits a confirmation message to all relevant parties. The buyer now becomes the new registered owner of the sold item. In step 416, the database 116 optionally updates the bank's file to document the new registered owner of the tracking check 136 corresponding to the sold item. In one embodiment, the new registered owner also becomes the owner of the locked, deposited finds equal to the face value of the tracking check 136 corresponding to the sold item.

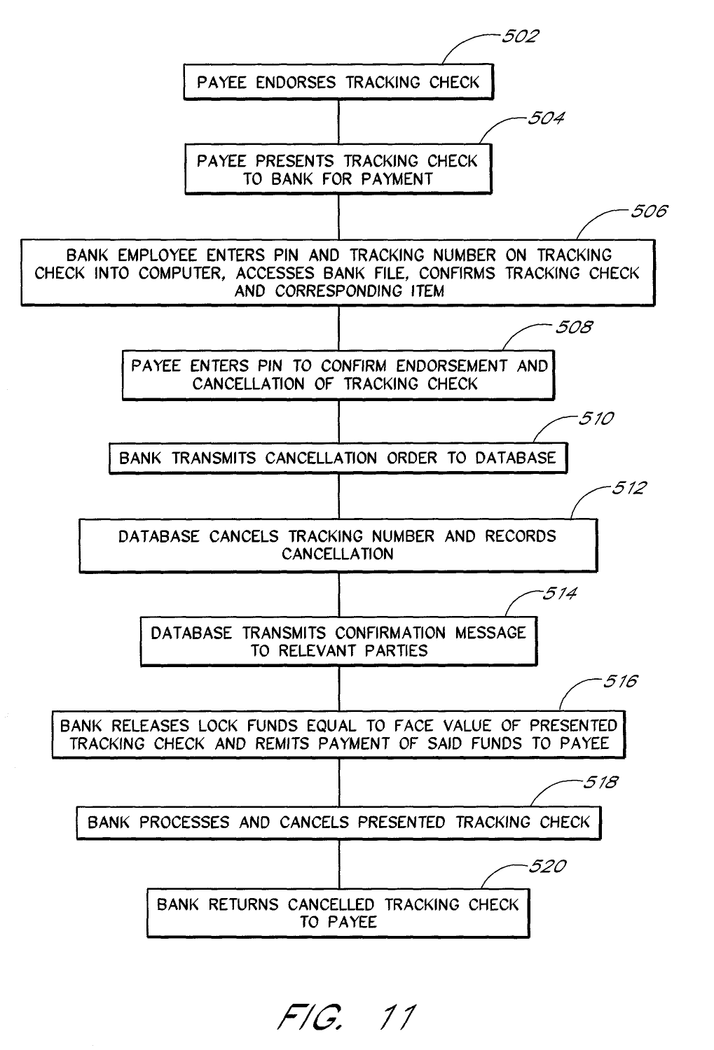

FIG. 11 is a flow diagram showing one embodiment of the tracking check endorsement and redemption process. The process begins with step 502 in which the payee of a tracking check 136 and its corresponding item decides to redeem a tracking check 136 for face value and endorses the tracking check 136 in an acceptable manner. In step 504, the payee presents the tracking check 136 to the appropriate bank 104 for payment. In one embodiment, the tracking check 136 is physically attached to its corresponding item. In another embodiment, the tracking number 134 is attached to the corresponding item, but the tracking check 136 is not attached to the item. In step 506, the bank 104 accesses the bank file pertaining to the presented tracking check 136. The bank 104 confirms that the tracking check 136 and the corresponding item are listed in the database 116 as belonging to the payee.

Still referring to FIG. 11, in step 508 the payee enters his/her PIN into the database 116 to confirm the endorsement and cancellation of the tracking check 136. In step 510, the bank 104 transmits a cancellation order for the tracking check 136 to the database 116. In step 512, the database 116 cancels the tracking number 134 of the tracking check 136 and records the cancellation. In step 514, the database 116 transmits a confirmation notice to all relevant parties. In step 516, the bank 104 releases the lock on the funds equal to the face value of the presented tracking check 136 and remits payment of said funds to the payee. If the payee has presented tracking check 136 to the bank 104 as attached to the corresponding item, the bank 104 also returns the item to the payee. In one embodiment, the bank 104 places a mark of cancellation on the tracking check 136, such as a stamp of “cancelled”, and so forth. In step 518, the bank 104 processes and cancels the tracking check 136, nullifying its status as a negotiable instrument. In step 520, the bank 104 optionally returns the cancelled tracking check 136 to the payee. In one embodiment, if the bank 104 has not returned the item to the payee in step 514, the bank 104 then returns the item to the payee in step 520.

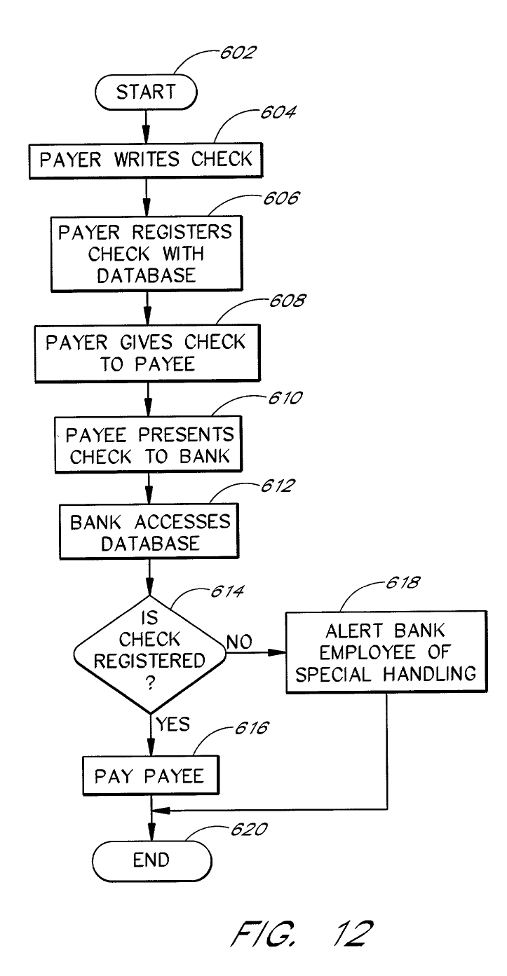

FIG. 12 is a flow diagram showing one embodiment of the process of registering checks and confirming check registration to prevent check fraud and forgery. From a start block 602, the process proceeds to a block 604, where a payer writes a check payable to a payee. The check includes a tracking number 134. The process proceeds to a block 606, where the payer registers the check with the database 116. The payer accesses the database 116, enters his or her customer PIN, and registers the check as an authentic check issued by the payer. The payer enters the tracking number 134 of the check. The payer also advantageously registers with the database 116 the payee of the check, the payment amount, the date, and other optional information. In one embodiment of electronic banking, the payer creates an electronic check and automatically registers the electronic check with the database 116.

The process proceeds from the block 606 to a block 608, where the payer gives the registered check to the payee. The payer may deliver the check to the payee by mail or by hand. The payer may also deliver an electronic check to the payee by email and other means of electronic transaction. The process proceeds to a block 610, where the payee receives the check and presents it to a bank for payment. The process proceeds to a block 612, where the bank access the database 116 and attempts to find out the registration status of the presented check. The bank enters the tracking number 134 of the check into the database 116 in order to find the check.

The process then proceeds to a decision block 614, where a determination is made as to whether the check is registered in the database 116. If the check is registered, then the process proceeds to a block 616. Otherwise the process proceeds to a block 618. In one embodiment, if the check is registered, the bank also determines if the registered information about the check, such as its payer, payee, payment amount, and date match the information in the presented check. In one embodiment, the payee registers with the database 116 in order to endorse the check.

At the block 616, the bank pays the face value of the check to the payee. The process proceeds from the block 616 to an end block 620. At the block 618, where the check is not registered, the bank is alerted of the special status of the check. Special rules are applied to handle the check. In one embodiment, the bank refuses to redeem a check that is unregistered. The bank also refuses to endorse a check whose registration information does not match the information on the check. In another embodiment, the bank conducts additional identity check before redeeming an un-registered check. For example, the bank requests the payee to prove his or her identity before redeeming the check. In another example, the bank contacts the payer to obtain a confirmation from the payer before redeeming the check. After the special status check is handled to a conclusion, the process proceeds to the end block 620.

The present invention may be embodied in other specific forms without departing from the essential characteristics as described herein. The embodiments described above are to be considered in all respects as illustrative only and not restrictive in any manner. The scope of the invention is indicated by the following claims rather than by the foregoing description.

What is claimed is:

1. A method for tracking physical property with an American Banking Association routing number, the method comprising:
associating a tracking number with an item of physical property, wherein the tracking number comprises at least an American Banking Association routing number;
recording in a database a description of the physical property; and
associating within the database the tracking number with the description about the physical property.

2. The method of claim 1, wherein associating the tracking number with the item of physical property comprises attaching a label displaying the tracking number to the item of physical property.

3. The method of claim 1, wherein associating the tracking number with the item of physical property comprises printing the tracking number on the item of physical property.

4. The method of claim 1, wherein associating the tracking number with the item of physical property comprises attaching a negotiable instrument comprising the tracking number to the item of physical property.

5. The method of claim 1, wherein the description of the physical property comprises a description about the owner of the physical property.

6. The method of claim 1, wherein the description of the physical property comprises a description about the possessor of the physical property.

7. A method for registering and tracking an item, the method comprising:
storing information about an item in a database;
associating within the database a tracking code with the information about the item, wherein the tracking code also identifies a negotiable instrument;
registering in the database an owner of the item;
transferring ownership of the item to a second party; and
changing the registered owner of the item in the database to the second party.

8. The method of claim 7, wherein the tracking code comprises a financially recognized tracking number, and wherein the tracking number comprises at least an American Banking Association routing number.

9. The method of claim 7, wherein the tracking code comprises a financially recognized tracking number, a payer, a payee, and a face value amount.

10. A method for registering and tracking an item, the method comprising:
storing information about an item in a database;
associating within the database a tracking code with the information about the item, wherein the tracking code also identifies a negotiable instrument;
registering in the database a possessor of the item;
transferring possession of the item to a second party; and
changing the registered possessor of the item in the database to the second party.

11. The method of claim 10, wherein the tracking code comprises a credit card number and a check number.

12. A database for registering and tracking items, the database storing a plurality of items, each of the stored items comprising:
a financially recognized tracking number associated with the item;
a name of the item; and
a registered owner of the item.

13. The database of claim 12, wherein at least one of the stored items further comprises a registered possessor of the item.

14. The database of claim 12, wherein at least one of the stored items further comprises an insurance company of the item.

15. The database of claim 12, wherein at least one of the stored items further comprises a transaction history of the item.

16. The database of claim 12, wherein at least one of the stored items further comprises a physical location of the item.

17. A method for redeeming checks, the method comprising:
receiving a request to redeem a negotiable instrument, the negotiable instrument including a tracking number that uniquely identifies the negotiable instrument;
entering the tracking number into a database to retrieve a corresponding registration record of the negotiable instrument;
comparing the retrieved registration record with the negotiable instrument; and
redeeming the negotiable instrument if data associated with the registration record relates to data associated with the negotiable instrument.

18. The method of claim 17, wherein receiving a request to redeem a check comprises receiving a request to redeem an electronic check.

19. The method of claim 17, wherein comparing the retrieved registration record with the negotiable instrument comprises comparing a registered payment amount of the retrieved registration record with a face value of the negotiable instrument.

20. The method of claim 17, wherein comparing the retrieved registration record with the negotiable instrument comprises comparing a registered payee name of the retrieved registration record with a payee name of the negotiable instrument.

21. A method for tracking an item with a financially recognized tracking number, the method comprising: associating within a database a tracking code with data about an item, wherein the tracking code comprises financially recognized identification information.

22. A method for registering and tracking items of physical property, the method comprising:
an attaching step for attaching a financially recognized tracking code to an item of physical property;
a registering step for registering in a database information about the item of physical property; and
an associating step for associating within the database the tracking code with the registered information about the item of physical property.
